(19) United States
(12) Patent Application Publication
(10) Pub. No.: US 2011/0191494 A1
(43) Pub. Date: Aug. 4, 2011

(54) SYSTEM AND METHOD FOR BACKWARDS COMPATIBLE MULTI-ACCESS WITH PROXY MOBILE INTERNET PROTOCOL

(76) Inventors: Zoltán Richard Turányi, Szentendren (HU); Christian Vogt, San Jose, CA (US)

(21) Appl. No.: 12/994,813

(22) PCT Filed: Oct. 10, 2008
(86) PCT No.: PCT/IB08/02689

§ 371 Date: Apr. 13, 2011

Related U.S. Application Data
(60) Provisional application No. 61/056,242, filed on May 27, 2008.

(51) Int. Cl. G06F 15/173

(52) U.S. Cl. 709/242

(57) ABSTRACT

A system and method of changing traffic from a first access associated with a first access router to a second access associated with a second access router utilized by a terminal in a telecommunication network using PMIP. The method begins by the terminal sending a first message to a Local Mobility Anchor (LMA), through the second access router, requesting a change of access from the first access to the second access. The LMA receives the first message and installs a new routing state associated with the second access router and the second access. A second message is then sent from the LMA to the terminal acknowledging the change in access of the terminal to the second access. The routing state associated with the second access router and the second access is then installed in the terminal.

### CROSS-REFERENCE TO RELATED APPLICATIONS

This application claims the benefit of U.S. Provisional Application No. 61/056,242, filed May 27, 2008, the disclosure of which is incorporated herein by reference.

### BACKGROUND

The present invention relates to communications networks. More particularly, and not by way of limitation, the present invention is directed to a system and method providing backwards compatible multi-access with Proxy Mobile Internet Protocol (PMIP) in a telecommunications network.

PMIP is a newly introduced network-based mobility protocol. Network-based mobility management enables Internet Protocol (IP) mobility for a host without requiring its participation in any mobility related signaling. The network is responsible for managing IP mobility on behalf of the host. The mobility entities in the network are responsible for tracking the movements of the host and initiating the required mobility signaling on its behalf. PMIP provides the protocol for such an environment. However, PMIP supports mobility of only a single interface of the attached hosts. If a host attempts to attach via more than one interface at the same time and the access network it attaches to uses PMIP, then the Local Mobility Anchor (LMA) assigns different IPv6 address prefixes (or IPv4 IP addresses) to each attaching interface.

It is often desired by a host to use only a single address for communication even across multiple access networks. In addition, it is oftentimes desirable to keep more than one attachment alive at a time if the terminal is capable, for example a dual-radio terminal. The benefit of such multiple live attachments is quicker handover between accesses (i.e., no need to discover and perform an attach procedure when handover is needed) and the ability to use both accesses simultaneously.

The benefit of using both accesses simultaneously is best achieved if it is invisible to individual applications. In particular, it is advantageous if the applications see a single IP address and uses that address for communication. An external system (e.g., the Access Network Discovery and Selection Function newly defined in Third Generation Partnership Project (3GPP) Rel8) may then direct the IP stack in the client to assign pieces of traffic (i.e., specified flows) to individual interfaces based on Quality of Service (QoS) capabilities, reliability, throughput properties of accesses, or for load balancing reasons.

Since PMIP assigns different prefixes to the client, session continuity when performing cross-interface handovers while keeping multiple interfaces attached is prevented. At the inception of PMIP, one of the main goals was to keep the hosts unaware of mobility. This goal is not necessary anymore when considering simultaneous multi-access. With simultaneous multi-access, the host must actively participate in the selection of the active interface to use. Specifically, there must be an explicit mechanism between the network and the host to agree on which interface to use, or in case of using multiple accesses, which flows are used with which access.

Nevertheless, operators may still desire to use PMIP, even in the multiple-access scenario described above since many operators have invested in a PMIP-based infrastructure. Fixed accesses rarely use Client Mobile IP (MIP), therefore PMIP is normally utilized. In addition, easy backwards compatibility is needed. Specifically, terminals having just one interface should still be unaware of the mobility. Additionally, in this case, terminals need not have a Client MIP stack.

Thus, a problem arises when a terminal, that is capable of multiple attachments at the same time, performs multiple attachments in PMIP networks. A system and method is needed which enable the use of the same IP address for cross-interface handovers or for full simultaneous multi-access. It would be advantageous to have a terminal which utilizes the same IP address while enabling cross-interface handovers and full simultaneous multi-access.

### SUMMARY

The present invention is a system and method providing backwards compatible multi-access with Proxy Mobile Internet Protocol (PMIP) in a telecommunications network. Thus, in one aspect, the present invention is directed to a method of changing traffic from a first access associated with a first access router to a second access associated with a second access router utilized by a terminal in a telecommunication network using PMIP. The method begins by the terminal sending a first message to a Local Mobility Anchor (LMA), through the second access router, requesting a change of access from the first access to the second access. The LMA receives the first message and installs a new routing state associated with the second access router and the second access. A second message is then sent from the LMA to the terminal acknowledging the change in access of the terminal to the second access. The routing state associated with the second access router and the second access is installed in the terminal.

In another aspect, the present invention is directed to a system for changing traffic from a first access to a second access in a telecommunication network using PMIP. The system includes a terminal operating in the telecommunications network, a first access router in the telecommunications network associated with the first access, a second access router in the telecommunications associated with the second access, and a LMA for controlling access by the terminal in the telecommunications network. The terminal sends a first message through the second access router to the LMA requesting a change of access from the first access to the second access. The LMA, in response to receipt of the first message, installs a new routing state associated with the second access router and the second access. The LMA also sends a second message from the LMA to the terminal acknowledging changing access of the terminal to the second access. The terminal, upon receipt of the second message, installs the new routing state, thereby changing the access by the terminal to the second access.

In still another aspect, the present invention is a control node for changing traffic from a first access associated with a first access router to a second access associated with a second access router utilized by a terminal in a telecommunication network using PMIP. The control node receives a first message sent from the terminal requesting a change of access from the first access to the second access and, in response to receipt of the first message, installs a new routing state associated with the second access router and the second access. The control node then sends a second message from the control node to the terminal acknowledging changing access of the terminal to the second access and providing the new routing state to the terminal. In one embodiment, the control node is an LMA.

In another aspect, the present invention is directed a control node for changing traffic from a first access associated with a first access router to a second access associated with a second access router utilized by a terminal in a telecommunication network using PMIP. The control node sends a first message sent from the terminal commanding a change of access from the first access to the second access. The control node installs a new routing state associated with the second access router and the second access. The control node receives a second message from the terminal to the control node acknowledging receipt of the first message and installation of the new routing state in the terminal.

### BRIEF DESCRIPTION OF THE DRAWINGS

In the following section, the invention will be described with reference to exemplary embodiments illustrated in the figures, in which:

FIG. 1 is a simplified block diagram illustrating components of a telecommunications network utilizing PMIP;

FIG. 2 is a signaling diagram illustrating the signal messaging between the LMA, MAG, and the MN according to the teachings of the present invention;

FIGS. 3A and 3B are flow charts illustrating the steps of changing an access for a terminal according to the teachings of the present invention; and

FIG. 4 is a signaling diagram illustrating the signal messaging between the LMA, MAG and the MN in an alternate embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

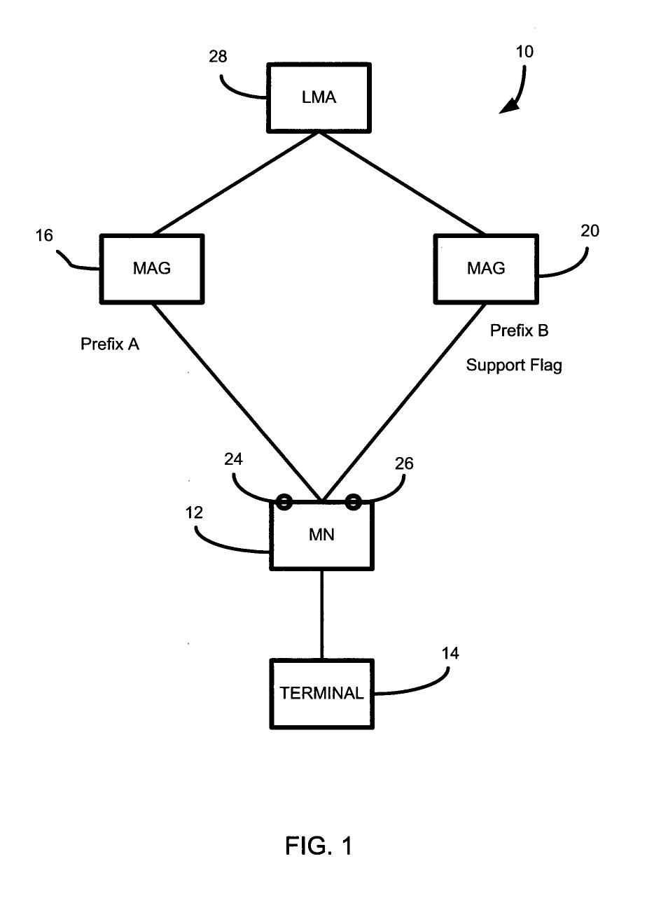

FIG. 1 is a simplified block diagram illustrating components of a telecommunications network 10 utilizing PMIP. The telecommunications network 10 includes a Mobile Node (MN) 12 in communication with a terminal 14. A Mobility Access Gateway (MAG) 16 supports the MN 12 and terminal 14 with a Prefix A and an address A::1. A MAG 20 supports the MN 12 and terminal 14 with a Prefix B and a configured address B::2.

The telecommunications network 10 conducts attaching procedures as proscribed by the PMIP. The Prefix A is attached by the MAG 16 to the MN 12 at 24. In addition, Prefix B is attached by the MAG 20 to the MN 12 at 26. The MAG 16 and MAG 20 communicate with a Local Mobility Anchor (LMA) 28. In a Proxy Binding Update (PBU), however, the MAGs 16 and 20 indicate support for this feature (e.g., support flag). The LMA 28 acknowledges support in a Proxy Binding Acknowledgement (PBA). Thus, at the time of the receipt of the PBA, the MAG knows if the network 10 is ready to support this feature. In some networks, it may be possible that some MAGS do not support this feature while other MAGs support this feature. However, traffic may still be moved to MAGs that support this feature, even if the original MAG does not support the feature.

If a handover happens in one of the accesses, the new MAG (e.g., MAG 20) is notified in a PBA message by the LMA about the routing exceptions that were installed at the previously used MAG before the handover. The LMA 28 changes downlink routing not only for the prefixes and addresses assigned to that access, but also for all the routing exceptions that used the previous MAG. In the situation where a new MAG does not support this feature, preferably the feature of the present invention is turned on or off uniformly in an access network. A terminal may in such a case attempt to route packets with routing exceptions via the new MAG, but the MAG may drop them due to the incorrect IP source address. Nevertheless, the terminal may ascertain a lack of support on the new MAG once it receives from that MAG a Router Advertisement message without a Routing Exception Permitted option.

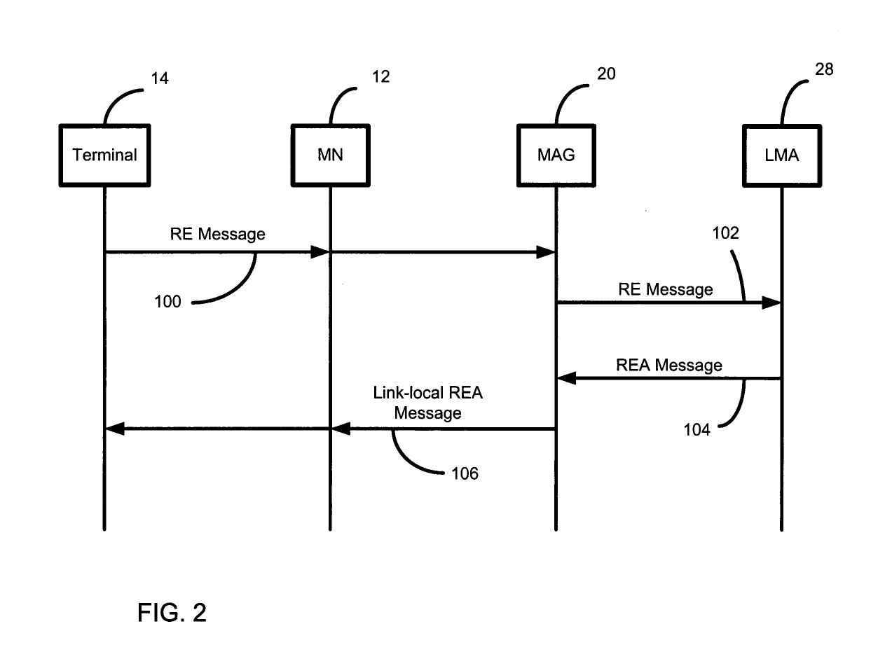

FIG. 2 is a signaling diagram illustrating the signal messaging between the LMA 28, MAG 20 and the MN 12 according to the teachings of the present invention. When the terminal 14 desires to move traffic via another interface, the terminal sends a link-local Routing Exception (RE) message 100, via the MN 12 to its access router (MAG 20) indicating that the terminal wishes to move traffic to another interface. (The MAG, MAG 16 currently serving the traffic is not notified.) The RE message 100 may be a User Datagram Protocol (UDP) packet to a well-known port or any other message format that will generate an Internet Control Message Protocol (ICMP) error when not recognized by the recipient. If the access router is not a MAG, or it is a MAG that does not support this feature, or the terminal is served by an LMA that does not support this feature, the access router responds with a rejection message. Otherwise, the MAG 20 forwards the message as a RE message 102 to the LMA 22 serving the terminal 14. The message may be re-formatted for transmission to the LMA 22. The MAG 20 may also send a PBU to the LMA 22 with appropriate extensions containing the information in the RE message. In addition, all previous routing exceptions established by the terminal in the MAG may also be sent with the appropriate extensions.

The message sent to the LMA contains the IP address of the terminal 14 which is used by the piece of traffic to be moved. In the simplest case, the terminal 14 uses only one IP address for communication and desires to move all of its traffic to another access. In a more complicated case, the individual IP flows may be specified, that may include different multiple IP addresses if the terminal uses more than one IP address for communication. The terminal 14 may also move full prefixes between the MAGs. It may be that the MAG or the LMA wants to support limited capabilities only, e.g., all traffic on a particular IP address (or prefix) which require the use of the same access, for example, due to limitations in the Policy and Charging Control infrastructure. If this is the case (e.g., all traffic on a particular IP address with the same access), the MAG 20 rejects the RE messages that contain IP flow descriptors with an appropriate error code.

When the LMA 28 receives the RE message 102 (or a PBU with appropriate extensions), the LMA checks if the IP addresses claimed by the terminal 14 are, in fact, assigned to the terminal in one of the attached accesses (or formed from prefixes assigned to the terminal). If the IP addresses claimed by the terminal are not assigned to the terminal in one of the attached accesses (or formed from prefixes assigned to the terminal), the LMA 22 rejects the message 102. The LMA 22 may optionally check the terminal 14's service profile to determine if the terminal is authorized for the requested traffic redirection. If the LMA 22 performs this optional check and finds that the terminal is not authorized for the requested traffic redirection, the LMA 22 rejects the RE message 102. Otherwise, the LMA installs a new routing state as requested by the RE message 102. The LMA then sends a Routing Exception Acknowledgement (REA) message 104 to the MAG 20 (or a PBA with appropriate extensions). If the RE message brought traffic on a new IP address (or prefix) to the MAG 20, the MAG 20 also installs a routing state for that IP address (or prefix). In addition, the MAG 20 sends a link-local REA message 106 to the terminal 14 via the MN 12. Receiving the REA message 106, the terminal 14 also installs the routing state that sends uplink traffic matching the content of the RE message to the newly selected interface. This routing state may be flow specific. In the case where a given flow is re-routed, flow descriptors are necessary to re-direct traffic (e.g., port numbers) in addition to IP addresses.

In regards to the relationship to existing IP networking and PMIP principles, the terminal 14 using the present invention is preferably a multi-homing terminal participating in routing via the RE messages. Specifically, the terminal informs relevant routers (e.g., the MAG and the LMA) that a certain address range is now better routed via a different path (i.e., via another interface). These states are considered as “routing exceptions” since these are not routed to the MAG (e.g., MAG 16) to which the IP address or prefix has been assigned by the LMA 28, but rather another MAG (e.g., MAG 20) is used for delivering such traffic. In addition, the IPv6 prefixes assigned by PMIP at attachment time to the access links stay the same throughout the entire lifetime of the PMIP session. If the terminal sends RE messages, it only changes the routing exceptions.

If a MAG (e.g., MAG 16) has installed an extra routing state for an IP address or prefix that the terminal 14 has brought to it using RE messages, in a preferred embodiment of the present invention, this state is removed if the terminal has moved all traffic on this address or prefix further to another MAG (e.g., MAG 20). In this case, MAG 16 does not receive any notification that its entries are not being used any more. Thus, the LMA 28 may optionally send such removal messages attached to any PBA sent to MAG 16 for the terminal 14 (e.g., as part of a handover or periodic refresh) listing either the IP addresses and/or prefixes to remove or to maintain. If the terminal loses connectivity or actively detaches from a network whose IP address it still uses for communication, the IP address must be kept as a functioning IP address or prefix both in the terminal 14 and in the LMA 28. In contrast, if the terminal 14 has not sent any RE message for such IP address or prefix, then the IP address may be removed at detach time. The RE message may also be used to explicitly remove routing information, thereby returning such traffic to their original MAG (e.g., MAG 16). If the access is since detached, a release of those IP addresses or prefixes from the LMA may also be removed.

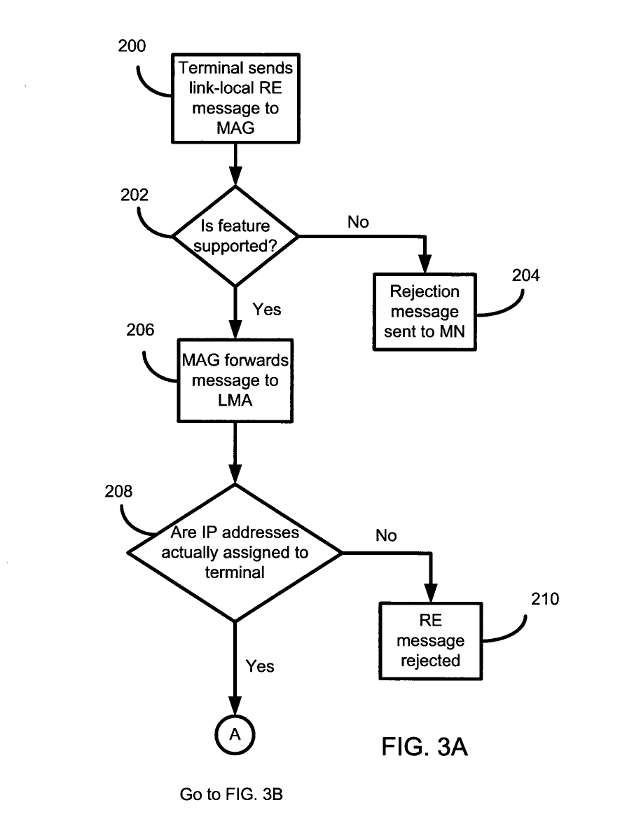

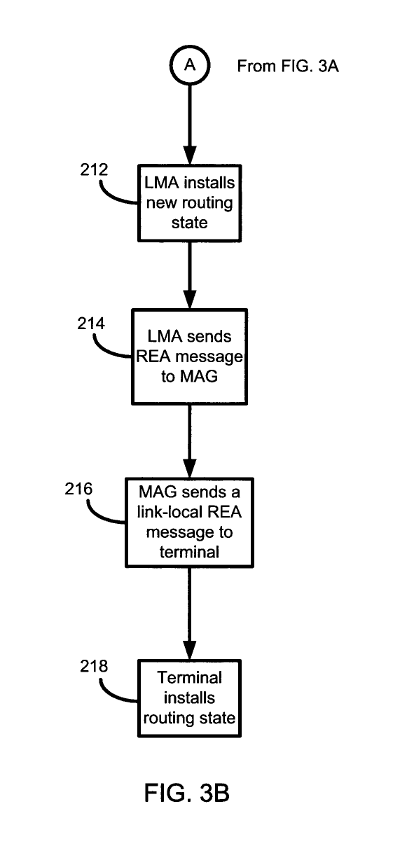

FIGS. 3A and 3B are flow charts illustrating the steps of changing an access for a terminal according to the teachings of the present invention. With reference to FIGS. 1-3, the method will now be explained. When the terminal 14 desires to move traffic via another interface, the method begins with step 200 where the terminal sends a link-local Routing Exception (RE) message 100, via the MN 12 to its access router (MAG 20) indicating that the terminal wishes to move traffic to another interface. The MAG currently serving the traffic to be moved is preferably not notified. The RE message 100 may be a UDP packet to a well-known port or any other message format that will generate an ICMP error when not recognized by the recipient. In step 202, it is determined if the feature is not supported (e.g., the access router is not a MAG, it is a MAG that does not support this feature, or the terminal is served by an LMA that does not support this feature). In step 202, if it is determined that the access router (e.g., MAG 20) does not support this feature, a rejection message is sent to the MN in step 204.

However, in step 202, if it is determined that the feature is supported, the MAG 20 forwards the message as a RE message 102 to the LMA 22 serving the terminal 14 in step 206. The message may be re-formatted for transmission to the LMA 22. The MAG 20 may also send a PBU to the LMA 22 with appropriate extensions containing the information in the RE message. In addition, all previous routing exceptions established by the terminal in the MAG may also be sent with the appropriate extensions.

Next, in step 208, when the LMA 22 receives the RE message 102 (or a PBU with appropriate extensions), the LMA determines if the IP addresses claimed by the terminal 14 are, in fact, assigned to the terminal in one of the attached accesses (or formed from prefixes assigned to the terminal). If it is determined in step 208 that the IP addresses claimed by the terminal are not assigned to the terminal in one of the attached accesses (or formed from prefixes assigned to the terminal), the method moves to step 210 where the LMA 22 rejects the message 102. The LMA 22 may optionally check the terminal 14's service profile to determine if the terminal is authorized for the requested traffic redirection. If the LMA 22 performs this optional check and finds that the terminal is not authorized for the requested traffic redirection, the LMA 22 rejects the RE message 102.

However, in step 208, if it is determined that the IP addresses claimed by the terminal are assigned to the terminal, the method moves to step 212 where the LMA installs new routing state as requested by the RE message 102. Next, in step 214, the LMA sends a Routing Exception Acknowledgement (REA) message 104 to the MAG 20 (or a PBA with appropriate extensions). If the RE message brought traffic on a new IP address (or prefix) to the MAG 20, the MAG 20 also installs routing state for that IP address (or prefix). Next, in step 21, the MAG 20 sends a link-local REA message 106 to the terminal 14 via the MN 12. Receiving the REA message 106, the terminal 14 also installs the routing state that sends uplink traffic matching the content of the RE message to the newly selected interface in step 218. This routing state may be flow specific.

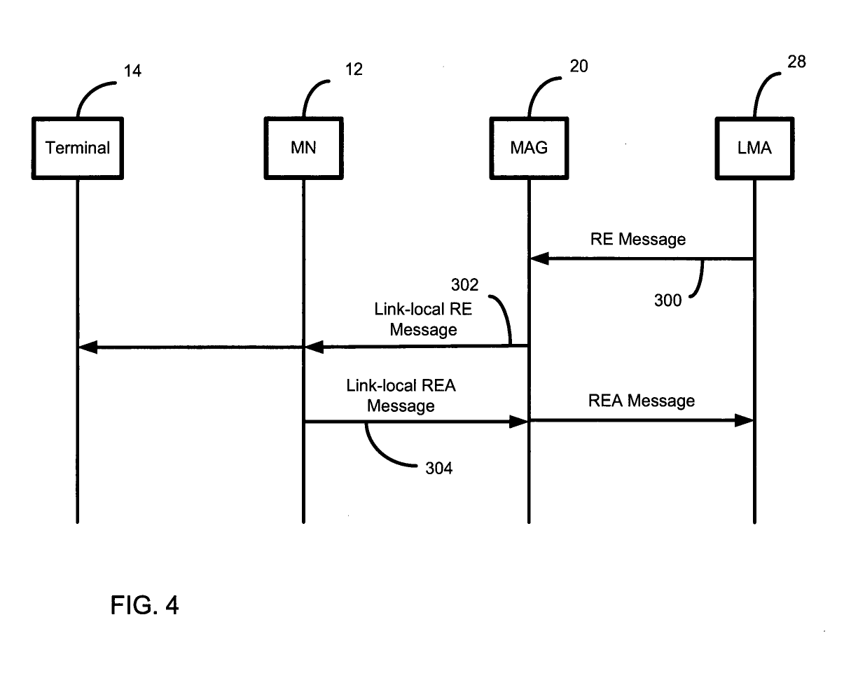

In an alternate embodiment of the present invention, the LMA 28 may initiate the process. FIG. 4 is a signaling diagram illustrating the signal messaging between the LMA 28, MAG 20 and the MN 26 in an alternate embodiment of the present invention. In this embodiment, an RE message 300 is sent by the LMA 28 to the MAG 20. The MAG 20 then sends a link-local message 302 to the terminal 14 via the MN 12. The MN then sends an REA message 304 to the MAG 20 and thereon to the LMA 28. However, in this particular case, the MN 12 may not be available over the radio interface that the LMA has selected (e.g., the link down event may not be detected by the MAG 20). In this case, the MAG 20 may attempt a few retransmissions, and, after being unsuccessful, send a negative REA to the LMA. The LMA may expect to get the negative REA after a relatively long period of time.

The present invention is fully backwards compatible to PMIP. Terminals with a single interface may still use PMIP without host involvement. Terminals with multiple interfaces may also use PMIP without host involvement, in which case the terminals need to live without session continuity between interfaces. The network does not need to know if a particular terminal supports this extension. If a terminal supporting these extensions roams into a legacy PMIP network or a network not employing PMIP at all, it can seamlessly fall back to currently used processes. The present invention also enables largely similar network operation to the original PMIP. In addition, the present invention enables either cross-interface handovers without requiring detaching in the old access. Addition, the present invention enables full simultaneous use of multiple PMIP accesses totally transparently to applications. The present system and method may be implemented with relatively little effort in the terminal. The present invention avoids the multi-link subnet problems, e.g., IP addresses being assigned only to a single interface. To utilize the present invention, the terminal only requires an access selection mechanism and a controller for this function. Apart from these modifications, only the routing part of the terminal needs modification if low-based simultaneous multi-access is needed.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method of changing traffic from a first access associated with a first access router to a second access associated with a second access router utilized by a terminal in a telecommunication network using Proxy Mobile Internet Protocol (PMIP), the method comprising the steps of:
sending a first message from the terminal to a Local Mobility Anchor (LMA) through the second access router requesting a change of access from the first access to the second access;
receiving the first message by the LMA;
installing a new routing state associated with the second access router and the second access;
sending a second message from the LMA to the terminal acknowledging changing access of the terminal to the second access; and
installing the routing state associated with the second access router and the second access in the terminal.

2. The method according to claim 1 wherein the first message is a routing exception message.

3. The method according to claim 2 wherein the routing exception message is a User Datagram Protocol packet.

4. The method according to claim 2, wherein the first access router sends a proxy Binding Update (PBU) in the routing exception message to the LMA, the PBU having appropriate extensions and previous routing exceptions established by the terminal.

5. The method according to claim 1 wherein the first access router and the second router are Mobility Access Gateways.

6. The method according to claim 1 further comprising the steps of:
determining by the second access router if the network supports a change of access feature, and
upon determining that the network does not support a change of access 5 feature, rejecting the first message.

7. The method according to claim 1 wherein the first access router reformats the first message for transmission to the LMA.

8. The method according to claim 1 wherein the first message includes an Internet Protocol (IP) address of traffic to be moved to the second access in the terminal.

9. The method according to claim 8 further comprising the steps of:
upon receiving the first message by the LMA, checking by the LMA to determine if the IP address of traffic is assigned to terminal; and
if the IP address is not assigned to the terminal, rejecting the first message.

10. The method according to claim 1 wherein the second message is a Routing Exception Acknowledgment (REA) message.

11. The method according to claim 10 further comprising the step of sending a link-local REA to the terminal by the second access router.

12. The method according to claim 1 wherein the routing state is flow specific.

13. The method according to claim 1 further comprising the step of, upon handing over access by the LMA to a third access router, providing routing exceptions associated with the second message to the third access router.

14. The method according to claim 1 wherein the LMA sends a removal message to the first access router listing Internet Protocol addresses to be removed in response to the change in access from the first access to the second access.

15. A system for changing traffic from a first access to a second access in a telecommunication network using Proxy Mobile Internet Protocol (PMIP), the system comprising:
a terminal operating in the telecommunications network;
a first access router in the telecommunications network associated with the first access;
a second access router in the telecommunications associated with the second access;
a Local Mobility Anchor (LMA) for controlling access by the terminal in the telecommunications network;
wherein the terminal has means for sending a first message through the second access router to the LMA requesting a change of access from the first access to the second access;
the LMA having means for, in response to receipt of the first message, installing a new routing state associated with the second access router and the
second access and means for sending a second message from the LMA to the terminal acknowledging changing access of the terminal to the second access;
whereby the terminal installs the new routing state upon receipt of the second message, thereby changing the access to the second access.

16. The system according to claim 15 wherein the first message is a routing exception message.

17. The system according to claim 15 wherein the first access router and the second router are Mobility Access Gateways.

18. The system according to claim 15 wherein the second access router includes means for determining if the network supports a change of access feature, and rejecting the first message if the network does not support a change of access feature.

19. The system according to claim 15 wherein the LMA includes means for determining if an Internet Protocol (IP) address for traffic associated with the request for change of access is assigned to terminal;
whereby, if the IP address is not assigned to the terminal, the LMA rejects the first message.

20. The system according to claim 15 wherein the routing state is flow specific.

21. The system according to claim 15 wherein the LMA includes means for sending a removal message to the first access router listing Internet Protocol addresses to be removed in response to the change in access from the first access to the second access.

22. A control node for changing traffic from a first access associated with a first access router to a second access associated with a second access router utilized by a terminal in a telecommunication network using Proxy Mobile Internet Protocol (PUP), the control node comprising:
means for receiving a first message sent from the terminal requesting a change of access from the first access to the second access;
means for, in response to receipt of the first message, installing a new routing state associated with the second access router and the second access; and
means for sending a second message from the control node to the terminal acknowledging changing access of the terminal to the second access
and providing the new routing state to the terminal.

23. The control node according to claim 22 wherein the first message is a routing exception message.

24. The control node according to claim 22 wherein the control node is a Local Mobility Anchor.

25. The control node according to claim 24 wherein the LMA includes means for determining if an Internet Protocol (IP) address for traffic associated with the request for change of access is assigned to terminal;
whereby, if the IP address is not assigned to the terminal, the LMA rejects the first message.

26. The control node according to claim 22 wherein the routing state is flow specific.

27. The control node according to claim 22 wherein the control node includes means for sending a removal message to the first access router listing Internet Protocol addresses to be removed in response to the change in access from the first access to the second access.

28. A control node for changing traffic from a first access associated with a first access router to a second access associated with a second access router utilized by a terminal in a telecommunication network using Proxy Mobile Internet Protocol (PMIP), the control node comprising:
means for sending a first message sent from the terminal requesting a change of access from the first access to the second access;
means for installing a new routing state associated with the second access router and the second access; and
means for receiving a second message from the terminal to the control node acknowledging receipt of the first message and installation of the new routing state in the terminal.

29. The control node according to claim 28 wherein the first message is a routing exception message.

30. The control node according to claim 28 wherein the control node is a Local Mobility Anchor.
